(19) United States
(12) Patent Application Publication
(10) Pub. No.: US 2013/0090991 A1
(43) Pub. Date: Apr. 11, 2013

(54) APPARATUS, SYSTEM, AND METHOD FOR TOLL PAYMENT VIA SMART PHONE

(71) Applicant: Rosa M. Underwood, Washington, DC (US)

(72) Inventor: Rosa M. Underwood, Washington, DC (US)

(73) Assignee: VERIZON PATENT AND LICENSING INC., Basking Ridge, NJ (US)

(21) Appl. No.: 13/253,135

(22) Filed: Oct. 5, 2011

(51) Int. Cl. G07B 15/00

(52) U.S. Cl. 705/13

(57) ABSTRACT

An approach is provided for providing a toll payment apparatus, system, and method via smart device. A determination is made, on a user device, regarding proximity of the user device to a toll collection location, and payment of a toll is provided using the user device when the user device is within a predetermined distance of the toll collection location.

### BACKGROUND INFORMATION

An increase in the volume of traffic travelling on roads places an increasing burden on governments to maintain existing roads to prevent them from falling into disrepair, and to expand road capacity where needed. As governments struggle to find ways to finance the building and maintenance of roads, toll collection on such roads has proven to be a viable source of financing such projects in certain areas. However, current toll payment methods are very limited in the manner in which payments are made, and have a tendency to drastically slow down travel on toll roads in order to make such payments using conventional payment methods.

Based on the foregoing, there is a need for improved toll payment/collection options that makes payment easier and more efficient.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling toll payment using a smart device, according to an exemplary embodiment;

FIG. 2 is a diagram of a user device for use with a system for enabling toll payment, according to an exemplary embodiment;

FIG. 3 is a diagram of a toll payment/collection platform configured to manage a toll payment/collection program, according to an exemplary embodiment;

FIG. 4 is a workflow process executed by a user to subscribe to a toll payment/collection program, according to an exemplary embodiment;

FIG. 5A and FIG. 5B are, respectively, a process of providing toll payment using a smart device, and a process of providing a toll payment/collection program to a user, according to various embodiments;

FIGS. 6A-6D are diagrams of user devices enabling toll payment, according to various embodiments;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method and software for enabling toll payment via a smart device are described. In the following description, for the purposes of explanation, numerous specific details are set forth to provide a thorough understanding of the present invention. It is apparent, however, to one skilled in the art that the present invention may be practiced without these specific details or with an equivalent arrangement. In other instances, well-known structures and devices are shown in block diagram form to avoid unnecessarily obscuring the present invention.

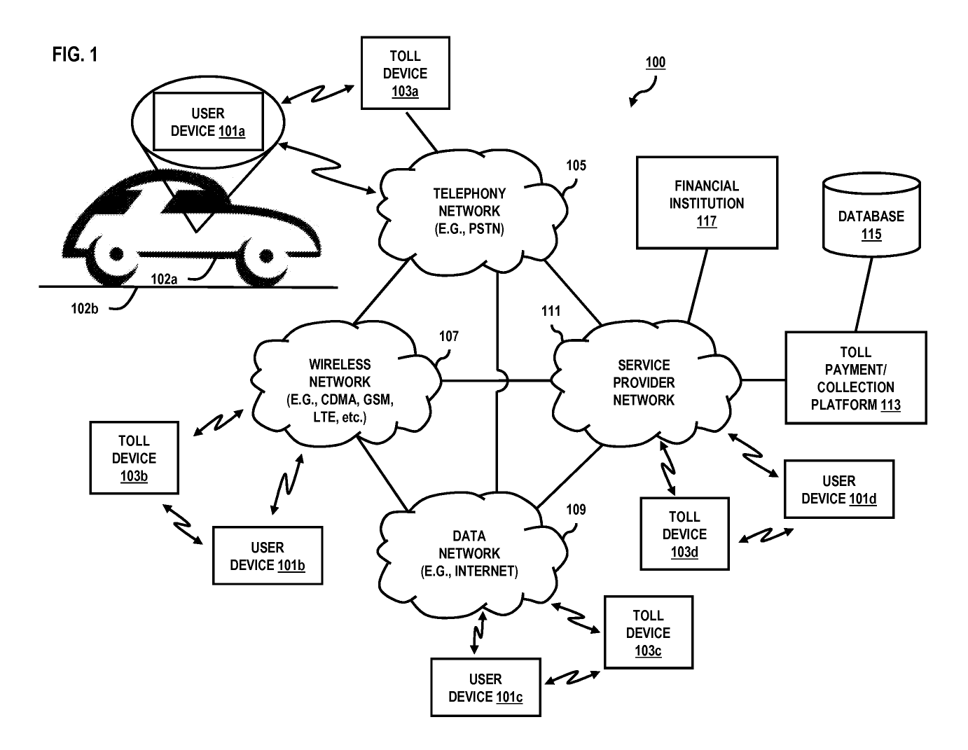

FIG. 1 is a diagram of a system for enabling toll payment via a smart device, according to one embodiment. For the purpose of explanation, system 100 is shown to include one or more smart user devices 101a-101d (e.g., mobile device, smart phone, netbook, laptop, or any communications enabled computing device) that can be provided in, for example, a vehicle 102a travelling on a road 102b (either provided as a built-in component thereof or as a portable device carried by a user), and that are configured to communicate with one or more toll devices 103a-103d (e.g., wireless communication devices, near-field communication devices, Radio Frequency Identification (RFID) systems, etc.) and with a service provider via one or more networks, such as a telephony network 105, a wireless network 107, a data network, and a service provider network 111. The toll devices 103a-103d can be used by a toll collection entity at a toll collection location or area.

A toll payment/collection platform 113, as managed by the service provider, can provide a toll payment/collection program to both subscribers and toll collection agencies. In one embodiment, the platform 113 is maintained by a service provider (e.g., a wireless communication company) as a hosted or subscription based service made available to users of devices 101a-101d through a service provider network 111. By way of example, the toll payment/collection platform 113 enables the service provider, individual users of devices 101a-101d subscribed with the service provider, and toll collection agencies to exchange payment information to provide for financial transaction between the users and the toll collectors. In alternative embodiments, however, the user device can be configured to directly manage the financial transaction between the user device and a financial institution without the need for the toll payment/collection platform 113.

The system 100 of FIG. 1 enables users of user devices, such as mobile phones and smartphones, to readily utilize the device during toll payment transactions. It is noted that user devices 101a-101d may be any type of mobile terminal, or portable terminal including a mobile handset, station, unit, device, multimedia computer, multimedia tablet, Internet node, communicator, netbook, computer, laptop computer, Personal Digital Assistants (PDAs), smartphone or any combination thereof. It is also contemplated that the user devices 101a-101d can support any type of interface for supporting the presentment or exchanging of data. In addition, user devices 101a-101d may facilitate various input means for receiving and generating information, including touch screen capability, keyboard and keypad data entry, voice-based input mechanisms and the like. Any known and future implementations of user devices are applicable. It is noted that in certain embodiments user devices 101a-101d may be configured to establish peer-to-peer communication sessions with each other using a variety of technologies—i.e., near field communication (NFC), Bluetooth, infrared, etc. Also, connectivity can be provided via a wireless local area network (LAN).

In system 100, according to certain embodiments, one or more networks, such as telephony network 105, wireless network 107, data network 109, and/or service provider network 111, are provided to handle various communication sessions between user device 101a-101d, the toll devices 103a-103d, and/or the toll payment/collection platform 113. Networks 105, 107, 109, and 111 may be any suitable wireline and/or wireless network. For example, telephony network 105 may include a circuit-switched network, such as the public switched telephone network (PSTN), an integrated services digital network (ISDN), a private branch exchange (PBX), or other like network.

Wireless network 107 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Meanwhile, data network 109 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 105, 107, 109, and 111 may be completely or partially contained within one another, or may embody one or more of the aforementioned infrastructures. For instance, service provider network 111 may embody circuit-switched and/or packet-switched networks that include facilities to provide for transport of circuit-switched and/or packet-based communications. It is further contemplated that networks 105, 107, 109, and 111 may include components and facilities to provide for signaling and/or bearer communications between the various components or facilities of system 100. In this manner, networks 105, 107, 109, and 111 may embody or include portions of a signaling system 7 (SS7) network, or other suitable infrastructure to support control and signaling functions.

The platform 113 stores information regarding subscriber information and toll collector information in a database 115. The platform and/or the devices 101a-101d can communicate with a financial institution 117 in order to make payments, authorize account balances, etc.

While implementations may vary, for the purpose of illustration, the toll devices can be provided at toll collection locations on various roads, and can communicate with the toll payment/collection platform 113 to manage toll payments from the subscriber to the toll collector. In one embodiment, the toll devices 103a-103d are computerized devices for conducting a financial or payment transaction in relation to toll collection. The toll device can connect to other systems and devices over a communication network, including those systems and devices directly within the environment of its operation as well as external systems. It may also be configured to enable communication with a user device 101a-101d using near field communication, Bluetooth, WiFi systems, Radio Frequency Identification (RFID) systems, or other wireless communication technologies.

The system 100 provides a dynamic toll payment/collection program that can allow a user to utilize an account (e.g., as managed using a user device 101a-101d) to pay tolls at various toll collection devices. Such an approach is not only advantageous to users, but is also advantageous to the toll collectors, since it is an efficient method of automatically providing payment to the toll collector without creating a dramatic slowing of traffic through the toll collection area.

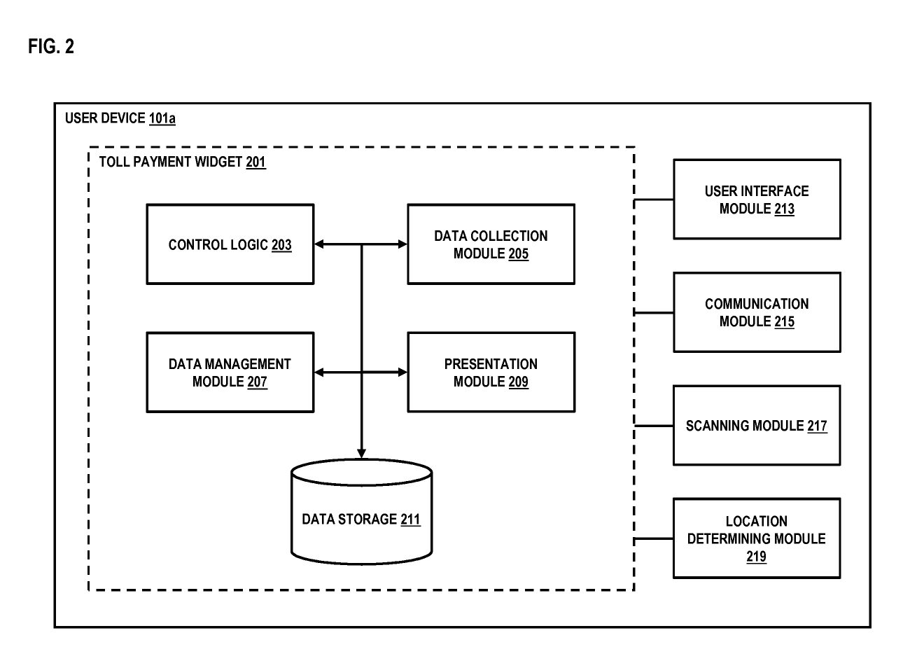

FIG. 2 is a diagram of a user device 101a for use with a system for enabling toll payment, according to an exemplary embodiment. The user device, as a smart device, can be any type of computing device configured to communicate with the toll devices in the manner discussed herein. In this embodiment, the user device 101a can be a mobile communication device, such as a smartphone, having a toll payment widget 201, such as a software application loaded and running on the user device 101a. The widget 201 can interact with a control logic module 203, a data collection module 205, a data management module 207, a presentation module 209, and a data storage 211. The control logic 203 is configured to control the operation of the widget 201, and its interaction with other components of the user device 101a. The data collection module 205 is configured to gather data regarding financial information of the user, positional/location information of the user device and toll device(s), mapping information, etc. for use by the widget 201. The data management module 207 is configured to control the flow and storage of data amongst the modules, and can be configured by user settings to control the overall operation of the widget 201. The presentation module 209 is configured to present or display a user interface to the user, such as displaying mapping information, positional/location information of the user device and/or toll device(s), prompt the user for input, provide information to the user, etc.

The user device 101a further includes a user interface module 213, a communication module 215, a scanning module 217, and a location determining module 219. The user interface module 213 can be used in conjunction with the presentation module 209 to present information to the user via a display screen on the user device 101a and receive input from the user. The user interface module 213 can also include sound generation or sound receiving devices, touchscreen interfaces, button interfaces, image capturing devices, etc. The communication module 215 is used in conjunction with the data collection module 205 and/or the presentation module 209 to communicate with the tool devices 103a-103d and/or the toll payment/collection platform 113 to transmit or receive data. The scanning module 217 can be an image capturing device or other scanning device that is configured to allow the user to receive data, for example, by scanning a barcode (e.g., a bimodal barcode), quick response (QR) code, numerical code, data code, etc. The location determining module 219 can be a global positioning system (GPS) device, a device that can be used to determine location based on triangulation using cellular data, or any other location determining device that operates alone or in combination with other devices to determine the location of the user device.

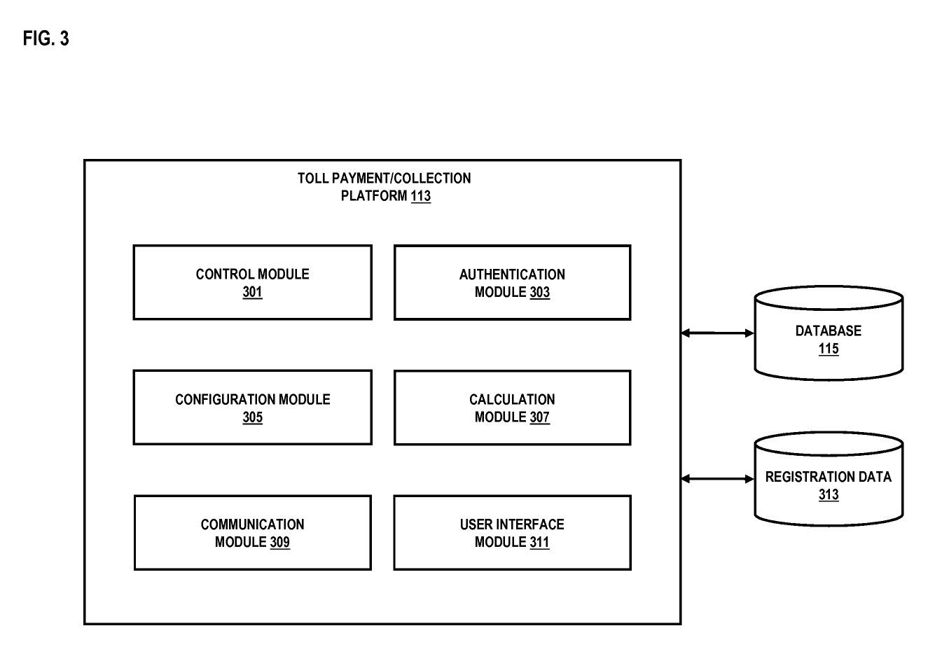

FIG. 3 is a diagram of a toll payment/collection platform 113 configured to manage a toll payment/collection program, according to an exemplary embodiment. The toll payment/collection platform 113 includes various executable modules for performing one or more computing, data processing and network based instructions that in combination provide a means of enabling the provisioning of resources of a packetized voice communication solution provider. Such modules can be implemented in hardware, firmware, software, or a combination thereof. By way of example, the toll payment/collection platform 113 may include a control module 301, an authentication module 303, a configuration module 305, a calculation module 307, a communication module 309, and a user interface module 311. In addition, the toll payment/collection platform 113 also maintains database 115, and registration database 313 pertaining to the various subscribers to the platform 113 and toll collectors.

In one embodiment, the control module 301 is configured to regulate the communication processes between the various other modules. For example, the control module 301 generates the appropriate signals to control the communication module 309 for facilitating transmission of data over the service provider network 111.

In one embodiment, the authentication module 303 authenticates users/subscribers and user devices 101a-101d and toll devices 103a-103d of the toll collectors for interaction with the platform 113. By way of example, the authentication module 303 receives a request from a user of a device 101 to subscribe to the toll payment/collection program service. The subscription process may include enabling communication between the user device and a toll device. Other settings may include specifying the method of communicating with the user device, such as e-mail, short messaging service (SMS) or as a web-based communication. In certain instances, the initial authentication process may also involve the downloading of a toll payment/collection program application or widget to respective user devices 101a-101d.

The authentication process performed by the module 303 may also include receiving and validating a login name and/or user identification value as provided or established for a particular user during a subscription or registration process with the service provider. The login name and/or user identification value may be received as input provided by the user from the user device or other device via a graphical user interface to the platform 113 (e.g., as enabled by user interface module 213). Alternatively, the login process may be performed through automated association of profile settings maintained as registration data 313 with an identification signal generated by an active device, i.e., a carrier detection signal or user identifier value determined via a toll device.

By way of example, the authentication module 303 receives messages from a toll device 103a indicating a request for authorization of payment of a toll. This message may be received from the toll device based on the detection of a signal from the user device 101a. It is noted, therefore, that the authentication process of module 303 may include determining if the user is registered.

In one embodiment, the configuration module 305 is used by the subscribers when establishing an account, defining the terms and conditions of use thereof, and providing necessary financial account information from which the platform 113 can obtain financial payments from a financial institution for the subscriber's account.

In one embodiment, the calculation module 307 can determine whether sufficient funds are in the subscriber's account to payment the toll. The calculation module 307 can also be used to provide mapping information to the subscriber including providing information locations of toll devices, estimated travel time and toll costs for proposed travel routes, etc. Alternatively, the user device can either provide such mapping information without the aid of the platform 113 or it can provide such mapping information in conjunction with the calculation module 307. The communication module 309 can communicate information to and receive information from the user devices, toll devices, financial institutions, etc.

As mentioned above, in one embodiment the user interface module 311 enables presentment of a graphical user interface on a user device. By way of example, the user interface module 311 generates a user interface in response to application programming interfaces (APIs) or other function calls corresponding to the web browser or web portal application of the user device for enabling display of graphical and textual elements.

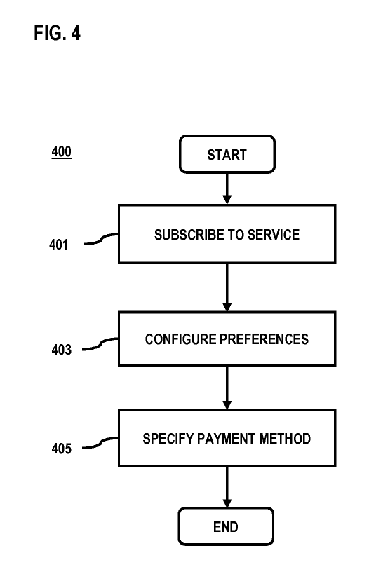

FIG. 4 is a workflow process 400 executed by a user to subscribe to a toll payment/collection service, according to one embodiment. The process 400 pertains to a subscriber (user) subscribing to a toll payment/collection program to allow for the payment of tolls. In step 401, the user subscribes to the service, and can establish a user account, identification number, authorization settings, other authorized users to the account, manner in which the account can be accessed, etc. In step 403, the user specifies their configuration preferences, such as whether they can send or receive information or other account communications via email, text message, web-based communication, etc. In step 405, the user specifies their payment method, such as providing financial institution information from which an account balance can be established and/or replenished.

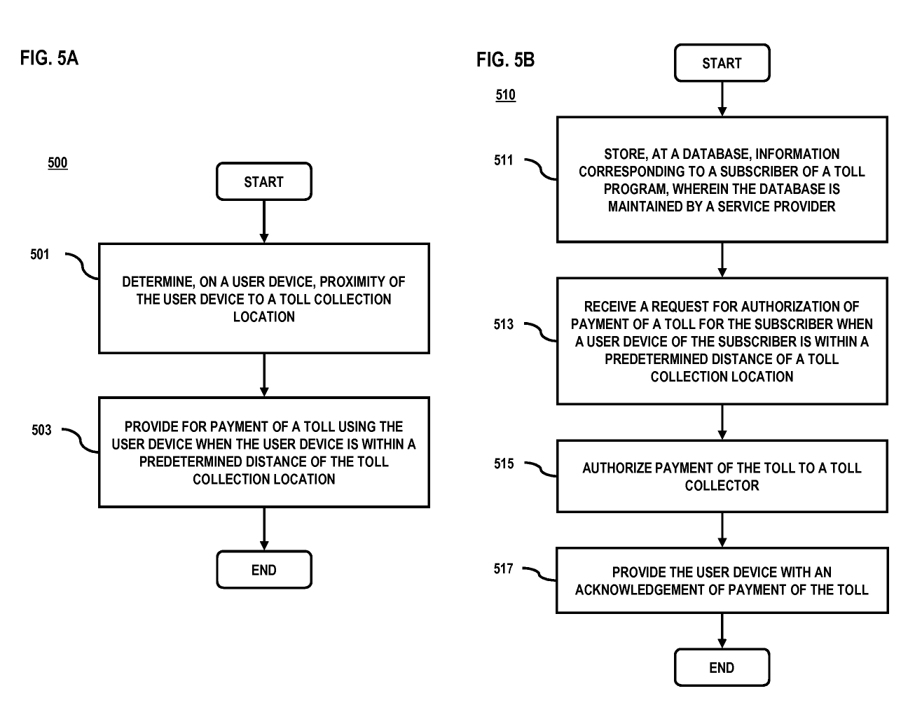

FIG. 5A is a process 500 of providing toll payment using a smart device, and FIG. 5B is a process 510 of providing a toll payment/collection program to a user, according to various embodiments.

While the embodiment in FIG. 5A is described in terms of a user device viewpoint and the embodiment in FIG. 5B is described in terms of a service provider viewpoint, these processes can be performed by either or both of the service provider or the user device. Additionally, these processes can be used individually or in combination with one another.

FIG. SA is a process 500 of providing toll payment using a smart device. In step 501, a determination is made on the user device regarding the proximity of the user device to a toll collection location. The determination can be made by the control logic 203 in conjunction with the data collection module 205 and the location determining module 219. For example, the determination can be made by using GPS data to determine the location of the user device, and location data regarding toll device locations that are in the area of the user device or on a predetermined route mapped using mapping software. Alternatively, the user device can use triangulation from cellular towers in order to determine the location of the user device, in combination with predetermined mapping data (e.g., downloaded on the user device, for example, by scanning a barcode or QR code on a printed map) that includes toll device/collection locations, in order to determine proximity between the user device and toll collection locations. In step 503, the user device can provide for payment of a toll when the user device is within a predetermined distance of the toll collection location. Thus, for example, once the user device is within communication range of the toll device, then a signal can be sent from the user device to the toll device to authorize payment of the toll. The predetermined distance can be set based on the communication range of the toll device and the user device based on the wireless communication technology used to communicate therebetween, and/or based on other relevant factors such as a predetermined safe distance to send and receive signals that allows for an amount of buffer time for possible communication problems, etc. The signal sent from the user device can act as payment, or it can authorize the toll device to contact the platform 113 in order to obtain authorization for payment and adjust the account balance in accordance with payment.

FIG. 5B is a process 510 of providing a toll payment/collection program to a user. In step 511, information corresponding to a subscriber of a toll program is stored at a database, such as database 115 connected to the platform 113 upon establishment of the user account. The database 115 and the platform 113 are maintained by a service provider. In step 513, the platform 113 provides for receipt of a request for authorization of payment of a toll for the subscriber when a user device of the subscriber is within a predetermined distance of a toll collection location. In step 515, payment of the toll is authorized to a toll collector, for example, if the subscriber's account is valid and has sufficient funds to pay the toll. In step 517, the user device is provided with an acknowledgement of payment of the toll.

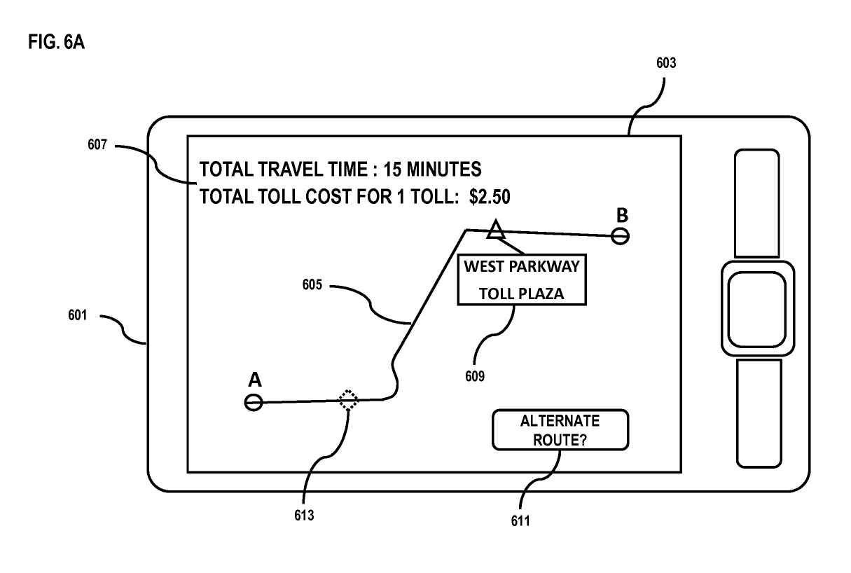

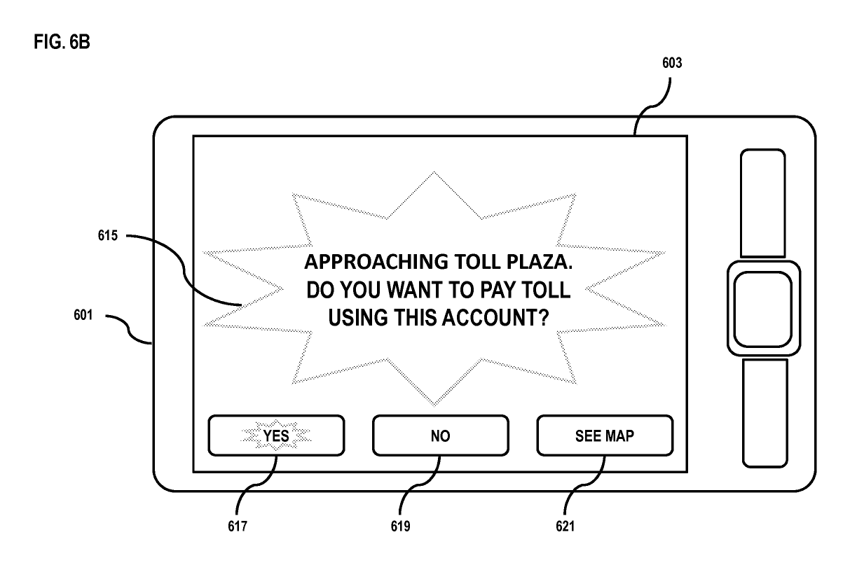

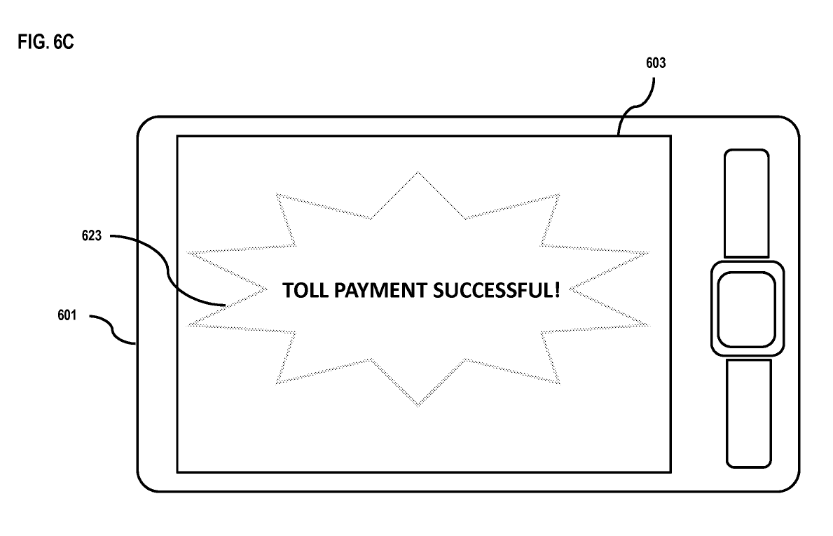

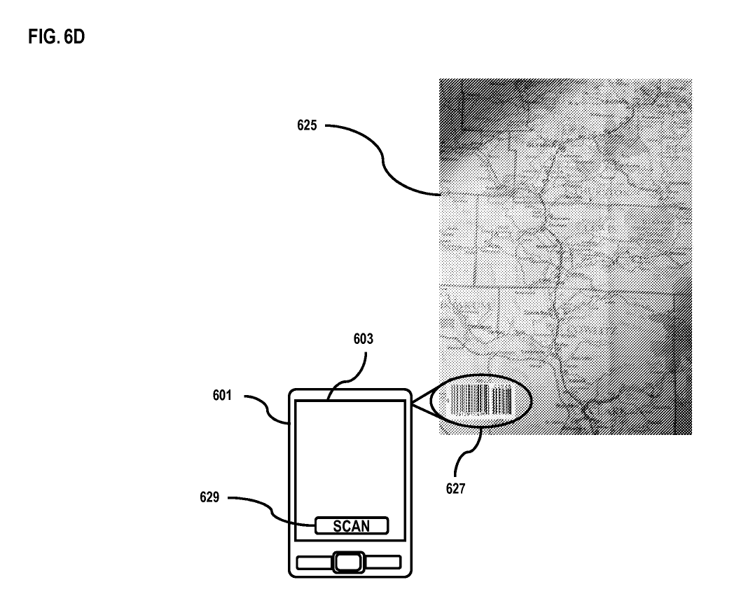

FIGS. 6A-6D are diagrams of user devices enabling toll payment, according to various embodiments.

FIG. 6A is a diagram of a user device 601 that has a display 603 that presents graphical user interface for a toll payment widget to the user. As shown in FIG. 6A, the display can provide a mapping feature that either is locally determined on the device or downloaded to the device that plots a map from location A to location B along route 605. The mapping feature can also provide other real-time navigational aids, such as turn-by-turn directions (e.g., written or vocal directions). The display 603 depicts the route 605 from start location A to end location B, and provides various information 607, such as total estimated travel time, which can include estimated delays at tolls or traffic delays, and total toll costs along the predetermined route 605. The display 603 can also show toll collection locations 609, and can provide an alternative route button 611, which can allow the user to select an alternative route based on such factors as shorter travel time or a route that avoids tolls, etc. The display 603 can also show an indicator 613 of the current location of the user device that can be updated in real-time as the user travels along the route 605, or even if the user leaves the predetermined route.

As shown in FIG. 6B, the display 603 can display a message 615 to the user during the travel along the route. For example, the display 603 can display message 615 at a predetermined distance from the toll collection location that indicates that the user is approaching the toll plaza, and asks the user for authorization to use the account to pay the toll. The display 603 can provide an accept button 617 and a decline button 619, and a button 621 that allows the user to return to the map. If the user selects the accept button 617, then, as shown in FIG. 6C, the display 603 can acknowledge when the payment has been successful (via a visual indicia 623), for example, when the toll device has received and acknowledged payment of the toll. Thus, the widget provides for display on the user device of a request for authorization for payment of the toll, and the widget provides for payment of the toll after receipt of authorization for payment of the toll in response to the request for authorization.

FIG. 6D depicts a scenario in which the user device 601 can be used to scan a pre-printed map 625 in order to obtain the mapping data needed to determine information, such as predetermined mapped routes, toll collection locations, etc. For example, the user device 601 can utilize an image capturing device (e.g., on rear surface of user device 601) or other scanning device to scan a barcode (or other code, such as a QR code, etc.) 627 on the pre-printed map 625 in order to determine the mapping data needed, such as predetermined mapped routes, toll collection locations, etc. The display 603 can provide a scan button 629 that allows the user to scan or otherwise read the barcode 627 for use in the toll payment widget.

Thus, a system and method of toll collection via a smart device is provided. The user can establish an account linked to a financial institution (e.g., bank account, checking account, credit card account, etc.), to a cellular service provider account, and/or an existing toll billing company, etc. in order to provide payment of the toll. The user can select an application (or widget) icon on the display of the smart device and can either use a navigation system or preprinted directions in order to utilize the toll payment/collection system.

For example, when using a navigation system such as a GPS navigation system, the user can enter a destination, and the widget can find route(s). Then, the widget can determine and announce that “Tolls exists at a total cost of x (currency) and travel time is 2 hours”, or “No tolls found in route.” The widget can determine this information in real-time or at predetermined update intervals (e.g., every minute, 5 minutes, etc.), and can provide information such as wait time at tolls, and number of toll plaza(s) along the route. The widget can also provide alternate route(s) with less tolls and/or less travel time.

Alternatively, a user can print or obtain predetermined directions (e.g., generated from navigation software or online website) or a pre printed map (e.g., a road map purchased at a store) that provides a code (e.g. bar code, QR code, etc.) that can provide data or provide a link to a site that provides data that can include, for example, road data, mapped trip data, toll location data, toll cost data, etc. The application (or widget) can use that data and data regarding a location of the user device (e.g., using GPS data, cellular triangulation data, etc.) to calculate a probability the user device will access a toll plaza based on, for example, a vector (e.g., decreasing vector analysis), in relation to toll plaza. An algorithm can be used to analyze data from, for example, an antennae placed on/at the toll plaza and cell site. Within a specified distance (e.g., determined by toll plaza facilitator), an announcement can be displayed on the user device advising that a toll plaza is in, for example, 4 miles, and a cost of the toll at the toll plaza.

Thus, the application (or widget) can determine of proximity of the user device to the toll collection location based upon global positioning data of the user device, based upon predetermined mapping data defining the toll collection location in comparison to cellular positioning data of the user device, etc.

Thus, according to various embodiments of the invention, as the user device approaches a toll plaza, when the user device is determined to be within a certain predetermined distance from the toll plaza, the user device sends the toll plaza device an encrypted signal (e.g., via Wi-Fi or other wireless communication technology) with account information of the user for toll deduction. The application (or widget) can announce that the toll payment was successful, and can announce a remaining balance. The user can have the option to link the account to a financial institution (e.g., a credit card account, banking account, etc.), cellular service provider, existing toll billing company, etc.

Embodiments can advantageously eliminate the need to obtain and affix a special device to a windshield, etc. for toll payments, and can provide flexibility in that toll can be paid by a driver or a passenger. Coins are advantageously not needed for the payment of tolls, and embodiments can decrease wait time at toll plazas.

The processes described herein for providing a system for enabling toll payment by smart device may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

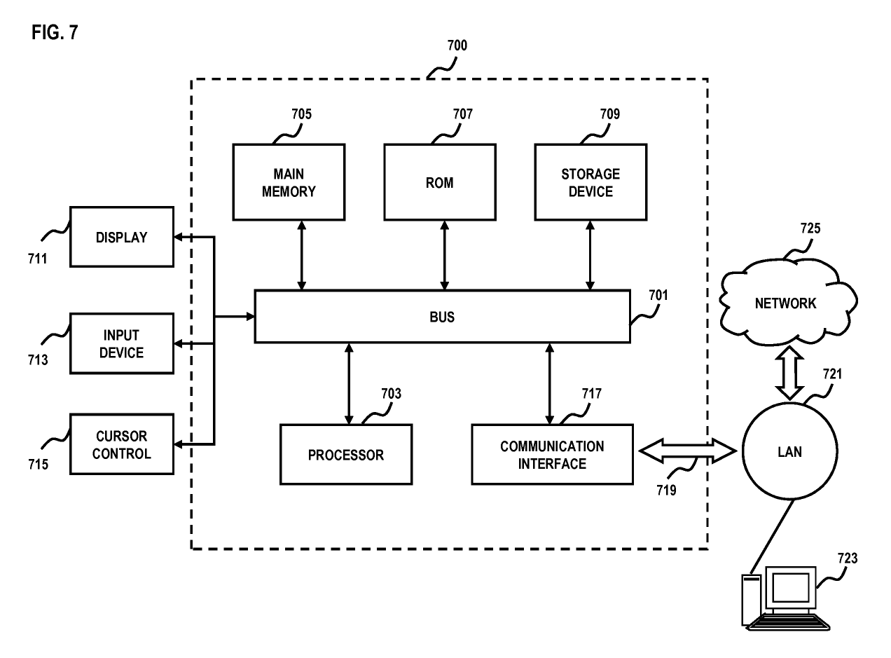

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

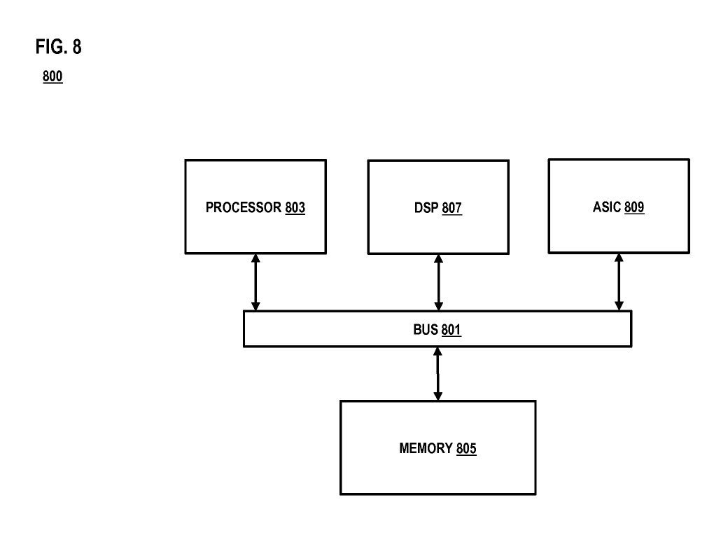

FIG. 8 illustrates a chip set or chip 800 upon which an embodiment of the invention may be implemented. Chip set 800 is programmed to enable a toll payment/collection program as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of placing and processing toll payment/collection programs.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable a toll payment/collection program. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining, on a user device, proximity of the user device to a toll collection location; and
providing for payment of a toll using the user device when the user device is within a predetermined distance of the toll collection location,
wherein the user device is a smart device.

2. A method according to claim 1, further comprising:
providing for display on the user device of a request for authorization for payment of the toll,
wherein the providing for payment of the toll occurs after receipt of authorization for payment of the toll in response to the request for authorization.

3. A method according to claim 1, wherein the providing for payment of the toll includes transmitting of a signal from user device providing for payment of the toll from a user account.

4. A method according to claim 3, wherein the signal is an encrypted signal containing information relating to the user account.

5. A method according to claim 1, wherein the determining of proximity of the user device to the toll collection location is based upon global positioning data of the user device.

6. A method according to claim 1, wherein the determining of proximity of the user device to the toll collection location is based upon predetermined mapping data defining the toll collection location in comparison to cellular positioning data of the user device.

7. A method according to claim 6, further comprising scanning a code using the user device to determine the predetermined mapping data.

8. A method according to claim 1, further comprising:
providing for a mapped route from a selected first location to a selected second location; and
providing for a total toll amount for the mapped route.

9. A method according to claim 1, further comprising:
providing for display on the user device of the proximity of the user device to the toll collection location.

10. An apparatus comprising:
at least one processor; and
at least one memory including computer program code for one or more programs,
the at least one memory and the computer program code configured to, with the at least one processor, cause the apparatus to perform at least the following,
determine proximity of the apparatus to a toll collection location,
provide for payment of a toll using the apparatus when the apparatus is within a predetermined distance of the toll collection location,
wherein the apparatus is a smart device.

11. An apparatus according to claim 10, wherein the apparatus is further caused to:
provide for display on the apparatus of a request for authorization for payment of the toll,
wherein the providing for payment of the toll occurs after receipt of authorization for payment of the toll in response to the request for authorization.

12. An apparatus according to claim 10, wherein the apparatus is further caused to provide for payment of the toll by transmitting of a signal from apparatus providing for payment of the toll from a user account.

13. An apparatus according to claim 12, wherein the signal is an encrypted signal containing information relating to the user account.

14. An apparatus according to claim 10, wherein the apparatus is further caused to determine proximity of the apparatus to the toll collection location based upon global positioning data of the apparatus.

15. An apparatus according to claim 10, wherein the apparatus is further caused to determine proximity of the apparatus to the toll collection location based upon predetermined mapping data defining the toll collection location in comparison to cellular positioning data of the apparatus.

16. An apparatus according to claim 15, wherein the apparatus is further caused to scan a code to determine the predetermined mapping data.

17. An apparatus according to claim 10, wherein the apparatus is further caused to:
provide for a mapped route from a selected first location to a selected second location; and
provide for a total toll amount for the mapped route.

18. An apparatus according to claim 10, wherein the apparatus is further caused to:
provide for display on the apparatus of the proximity of the apparatus to the toll collection location.

19. A method comprising:
storing, at a database, information corresponding to a subscriber of a toll program, wherein the database is maintained by a service provider;
receiving a request for authorization of payment of a toll for the subscriber when a user device of the subscriber is within a predetermined distance of a toll collection location;
authorizing payment of the toll to a toll collector; and
providing the user device with an acknowledgement of payment of the toll.

20. An apparatus comprising:
at least one processor; and
at least one memory including computer program code for one or more programs, the at least one memory and the computer program code configured to, with the at least one processor, cause the apparatus to perform at least the following,
store, at a database, information corresponding to a subscriber of a toll program, wherein the database is maintained by a service provider,
receive a request for authorization of payment of a toll for the subscriber when a user device of the subscriber is within a predetermined distance of a toll collection location,
authorize payment of the toll to a toll collector, and
provide the user device with an acknowledgement of payment of the toll.
